(19) United States
(12) Patent Application Publication
(10) Pub. No.: US 2026/0252238 A1
(43) Pub. Date: Aug. 27, 2026

(54) TRACKING VALIDITY OF ACCESS COUNTERS USING VALID BIT STRUCTURES

(71) Applicant: Micron Technology, Inc., Boise, ID (US)

(72) Inventors: Danilo CARACCIO, Milano (IT); Alessandro ORLANDO, Milano (IT); Massimiliano TURCONI, Gorgonzola (IT)

(21) Appl. No.: 19/457,250

(22) Filed: Jan. 23, 2026

Related U.S. Application Data
(60) Provisional application No. 63/762,716, filed on Feb. 25, 2025.

(51) Int. Cl. G06F 3/06

(52) U.S. Cl. CPC G06F 3/0611; G06F 3/0653; G06F 3/0683

(57) ABSTRACT

In some implementations, a memory system may receive, from a host system, an access request. The memory system may determine whether a valid bit structure, that is associated with the portion of the memory, is set to a first value or a second value, where the valid bit structure is set to the first value to indicate that a corresponding access counter is not valid or to the second value to indicate that a corresponding access counter is valid. The memory system may perform one of setting the valid bit structure to the second value and initializing an access counter that is associated with the valid bit structure based on determining that the valid bit structure is set to the first value, or incrementing the access counter based on determining that the valid bit structure is set to the second value.

### CROSS-REFERENCE TO RELATED APPLICATION

This Patent Application claims priority to U.S. Provisional Patent Application No. 63/762,716, filed on February 25, 2025, entitled “TRACKING VALIDITY OF ACCESS COUNTERS USING VALID BIT STRUCTURES,” and assigned to the assignee hereof. The disclosure of the prior Application is considered part of and is incorporated by reference into this Patent Application.

### TECHNICAL FIELD

The present disclosure generally relates to memory devices, memory device operations, and, for example, to tracking validity of access counters using valid bit structures.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, 1.5, or the like). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous dynamic RAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source. In some examples, a memory device may be associated with a compute express link (CXL) protocol and/or a CXL compliant memory system.

### BRIEF DESCRIPTION OF THE DRAWINGS

FIG. 1 is a diagram illustrating an example system capable of tracking validity of access counters using valid bit structures.

FIG. 2 is a diagram illustrating another example system capable of tracking validity of access counters using valid bit structures.

FIG. 3 is a diagram of an example of lost requests associated with an access counter.

FIG. 4 is a diagram of an example of tracking validity of access counters using valid bit structures.

FIG. 5 is a diagram of an example of components associated with tracking validity of access counters using valid bit structures.

FIG. 6 is a flowchart of an example method associated with tracking validity of access counters using valid bit structures.

### DETAILED DESCRIPTION

In some examples, memory controllers may manage access to memory resources in computing systems, such as via a hotness monitoring unit (HMU) of a memory controller or a similar access tracking component of the memory controller. For example, memory controllers may play a role in optimizing the performance of memory accesses by employing various tracking mechanisms. One such mechanism involves tracking “hot” pages, or memory pages that are frequently accessed, which can be leveraged to optimize memory management and access efficiency. To track these hot pages, hardware mechanisms such as hash functions, counting bloom filters (CBFs), first-in, first-out (FIFO) buffers, and/or similar mechanisms may be used by the memory controllers. For example, the hash functions may be used to index a CBF, which may contain counters to track the number of memory accesses, while a FIFO buffer may be used to store identifiers associated with the hot pages based on this tracking.

However, to ensure precise counting within defined time intervals (sometimes referred to herein as epochs), it may be necessary for the memory controller to reset the counters at the end of each time interval, posing certain challenges. For example, when the memory controller is managing a large number of counters, resetting the counters may take a non-negligible amount of time, even with certain hardware implementations. Moreover, while the counters are being reset, an HMU may be unable to track incoming memory accesses, leading to a loss of counting precision. In high-speed memory environments, this may result in hundreds or even thousands of missed memory accesses. Missing those accesses may decrease the accuracy of the system, potentially causing a page that should be identified as “hot” to be misidentified as “cold.” This loss of precision may undermine the efficiency of memory management and may result in suboptimal performance of the computing system.

Some implementations described herein provide a memory system with an optimized mechanism for tracking frequently accessed (e.g., “hot”) memory pages by employing an improved reset mechanism for counters associated with valid bit structures. For example, the memory system may receive an access request indicating that a portion of memory is to be accessed and determine whether a valid bit structure associated with that memory portion is set to a first value (indicating invalidity of an associated access counter for the current time interval) or a second value (indicating validity of the associated access counter for the current time interval). If the valid bit structure is set to the first value, the system may set the valid bit structure to the second value and may initialize the associated access counter. On the other hand, if the valid bit structure is set to the second value, the system may increment the access counter.

In some implementations, the memory system may reset all valid bit structures to the first value at the end of a monitoring period (e.g., an epoch) while maintaining the access counters at their current values. Additionally, or alternatively, the memory system may determine if any valid access counter satisfies a threshold during the monitoring period and, if so, the memory system may add an identifier associated with the memory portion to a data structure (e.g., a hotlist), which is accessible by the host system. In certain implementations, the valid bit structure corresponds to a valid-bit bloom filter and the access counter corresponds to a counting bloom filter, which collectively promote efficient tracking and resetting processes.

In this way, the memory system may conserve processing resources by implementing a reset mechanism in which only valid bit structures are reset rather than the access counters themselves, thereby minimizing the time needed for the reset operation. This efficiency reduces the operational overhead associated with tracking hot memory pages and eliminates the need for extended pauses during counter reset, allowing for continuous tracking of incoming memory accesses and thereby enhancing the precision of hotness tracking.

Furthermore, by more accurately identifying hot pages, as compared to examples in which memory accesses may be missed during a counter reset interval, the memory system may optimize memory management and allocation, which conserves memory resources and reduces overhead in memory operations. As a result, the overall performance and efficiency of the computing system may be improved, by ensuring that high-priority memory pages are recognized and managed effectively, leading to an optimized use of system resources.

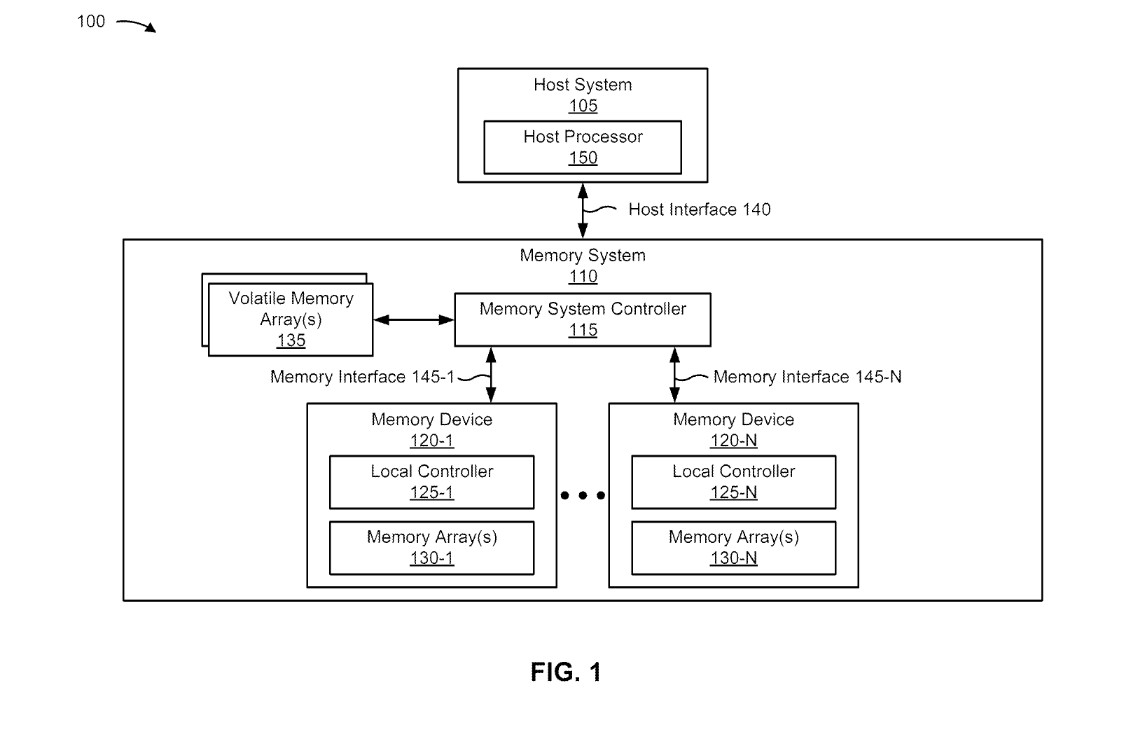

FIG. 1 is a diagram illustrating an example system 100 capable of tracking validity of access counters using valid bit structures. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N ≥ 1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N ≥ 1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a CPU, a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), a CXL memory module, and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, a CXL controller connected to DRAM, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off, and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

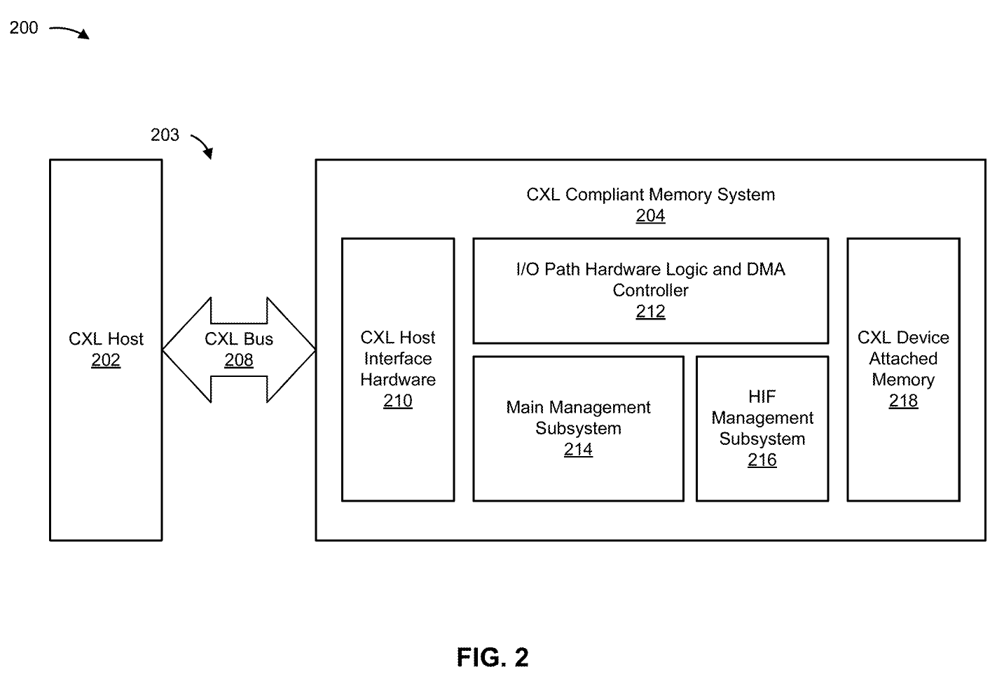

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, a DIMM interface, and/or a CXL interface (e.g., a PCIe/CXL interface, described in more detail below in connection with FIG. 2).

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to receive, from a host system, an access request indicating that a portion of a memory is to be accessed; determine whether a valid bit structure, of a plurality of valid bit structures, that is associated with the portion of the memory, is set to a first value or a second value, wherein each valid bit structure, of the plurality of valid bit structures, is associated with a respective access counter, of a plurality of access counters, and wherein each valid bit structure, of the plurality of valid bit structures, is set to the first value to indicate that the corresponding access counter is not valid or to the second value to indicate that the corresponding access counter is valid; and one of: set the valid bit structure to the second value and initialize an access counter, of the plurality of access counters, that is associated with the valid bit structure based on determining that the valid bit structure is set to the first value, or increment the access counter based on determining that the valid bit structure is set to the second value.

In some implementations, one or more systems, devices, apparatuses, components, and/or controllers of FIG. 1 may be configured to receive, from a CXL compliant host system, a CXL.mem request indicating that a portion of a memory is to be accessed; determine whether a valid bit structure, of a plurality of valid bit structures, that is associated with the portion of the memory, is set to 0 or 1, wherein each valid bit structure, of the plurality of valid bit structures, is associated with a respective counter structure, of a plurality of counter structures, and wherein each valid bit structure, of the plurality of valid bit structures, is set to 0 to indicate that the corresponding counter structure is not valid or 1 to indicate that the corresponding counter structure is valid; and one of: set the valid bit structure to 1 and set a counter structure, of the plurality of counter structures, that is associated with the valid bit structure to 1 based on determining that the valid bit structure is set to 0, or increment the counter structure based on determining that the valid bit structure is set to 1.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

FIG. 2 is a diagram illustrating another example system 200 capable of tracking validity of access counters using valid bit structures. The system 200 may include one or more devices, apparatuses, and/or components for performing operations described herein. In some examples, the system 200 may be associated with a CXL standard and/or protocol (e.g., the system 200 may utilize a CXL protocol to communicate between a host device, sometimes referred to as a CXL compliant host or simply a CXL host, and a memory system, sometimes referred to as a CXL compliant memory system or simply a CXL memory system). In that regard, the system 200 may include a CXL host 202 (which may correspond to the host system 105) and a CXL compliant memory system 204 (which may correspond to the memory system 110). The CXL host 202 and the CXL compliant memory system 204 may communicate via an interface 203 (e.g., host interface 140), which may include a CXL bus 208 (e.g., a PCIe/CXL interface), among other examples.

In some examples, the CXL compliant memory system 204 may be a system that complies with the CXL standard and/or protocol, such as for a purpose of communicating with one or more host devices (e.g., a CXL compliant host, such as CXL host 202). CXL is an open standard that may enable high-speed CPU-to-device and CPU-to-memory interconnects designed to accelerate next-generation performance. The CXL standard may enable memory coherency between the CPU memory space and memory on attached devices, which allows resource sharing for higher performance, reduced software stack complexity, and lower overall system cost. CXL is designed to be an industry open standard for enabling an interface for high-speed communications. CXL technology utilizes the PCIe infrastructure, leveraging PCIe physical and electrical interfaces to provide an advanced protocol in areas such as input/output (I/O) protocol, memory protocol, and coherency interface.

In some examples, the system 200 may include a PCIe/CXL interface (e.g., the CXL bus 208 may be associated with a PCIe/CXL interface), which may be a physical interface configured to connect the CXL compliant memory system 204 to CXL compliant host devices, such as the CXL host 202. In such examples, the PCIe/CXL interface may comply with CXL standard specifications for physical connectivity, ensuring broad compatibility and ease of integration into existing systems using the CXL protocol. Additionally, or alternatively, the CXL compliant memory system 204 may be designed to efficiently interface with computing systems (e.g., CXL host 202 and/or a host system 105) by leveraging the CXL protocol. For example, the CXL compliant memory system 204 may be configured to utilize high-speed, low-latency interconnect capabilities of CXL, such as for a purpose of making the CXL compliant memory system 204 suitable for high-performance computing, data center applications, artificial intelligence (AI) applications, and/or similar applications.

In some examples, the CXL compliant memory system 204 may include a CXL memory system controller (e.g., a CXL ASIC, which may correspond to the memory system controller 115 and/or local controller 125), which may be configured to manage data flow between memory arrays (shown as CXL device attached memory 218, which may correspond to the volatile memory arrays 135 and/or the memory arrays 130) and a CXL interface (e.g., the CXL bus 208). In some examples, the CXL memory system controller may be configured to handle one or more CXL protocol layers, such as an I/O layer (e.g., a layer associated with a CXL.io protocol, which may be used for purposes such as device discovery, configuration, initialization, I/O virtualization, direct memory access (DMA) using non-coherent load-store semantics, and/or similar purposes); a cache coherency layer (e.g., a layer associated with a CXL.cache protocol, which may be used for purposes such as caching host memory using a modified, exclusive, shared, invalid (MESI) coherence protocol, or similar purposes); or a memory protocol layer (e.g., a layer associated with a CXL.memory (sometimes referred to as CXL.mem) protocol, which may enable a CXL memory device to expose host-managed device memory (HDM) to permit a host device to manage and access memory similar to a native DDR connected to the host); among other examples.

The CXL compliant memory system 204 may further include and/or be associated with one or more high-bandwidth memory modules (HBMMs) or similar memory arrays (e.g., CXL device attached memory 218). For example, the CXL compliant memory system 204 may include multiple layers of DRAM (e.g., stacked and/or interconnected through advanced through-silicon via (TSV) technology) in order to maximize storage density and/or enhance data transfer speeds between memory layers. Additionally, or alternatively, the CXL compliant memory system 204 (e.g., a CXL ASIC of the CXL compliant memory system 204) may include a power management unit, which may be configured to regulate power consumption associated with the CXL compliant memory system 204 and/or which may be configured to improve energy efficiency for the CXL compliant memory system 204. Additionally, or alternatively, the CXL compliant memory system 204 (e.g., a CXL ASIC of the CXL compliant memory system 204) may include additional components, such as one or more error correction code (ECC) engines, such as for a purpose of detecting and/or correcting data errors to ensure data integrity and/or improve the overall reliability of the CXL compliant memory system 204. The CXL compliant memory system 204 may be implemented using a combination of hardware and firmware blocks and/or components. In such examples, the firmware may execute on one or more embedded CPUs within the CXL compliant memory system 204.

Additionally, or alternatively, the CXL compliant memory system 204 and/or a CXL memory system controller (e.g., a CXL ASIC) of the CXL compliant memory system 204 may include CXL host interface hardware 210, an I/O path hardware logic and DMA controller 212, a main management subsystem 214, and/or a host interface (HIF) management subsystem 216, among other examples. In some examples, the CXL host interface hardware 210 may be hardware components that enable physical connectivity between the CXL compliant memory system 204 and one or more external devices, such as to the CXL host 202 via the CXL bus 208. In some examples, the CXL host interface hardware 210 may include the necessary physical interfaces and protocol logic required to establish and/or maintain communication over the CXL link (e.g., via the CXL bus 208). In some cases, the CXL host interface hardware 210 may ensure that the CXL host 202 can access and/or control the CXL compliant memory system 204 efficiently.

The I/O path hardware logic and DMA controller 212 may handle data transfers between the CXL compliant memory system 204 and external devices, such as other memory modules and/or peripheral components. In some examples, a DMA controller portion of the I/O path hardware logic and DMA controller 212 may permit efficient data transfer without involving a CXL compliant memory system 204 CPU, directly. Put another way, the DMA controller portion of the I/O path hardware logic and DMA controller 212 may manage data movement between the CXL compliant memory system 204 and other system components, which may enhance overall system performance by offloading data transfer tasks from the CPU.

The main management subsystem 214 may serve as a central control and management unit within the CXL compliant memory system 204. In some examples, the main management subsystem 214 may encompass various functionalities and tasks, such as memory access control, error detection and/or correction, power management, and/or similar system management functionalities and/or tasks. Additionally, or alternatively, the main management subsystem 214 may ensure proper functioning and/or reliability of the CXL compliant memory system 204 and/or may optimize the performance of the CXL compliant memory system 204 under various operating conditions.

The HIF management subsystem 216 may be responsible for managing and/or controlling the CXL host interface hardware 210, among other tasks. In some examples, the HIF management subsystem 216 may handle tasks related to link initialization configuration negotiation with the CXL host 202, error handling, and/or other protocol-specific functionalities. Additionally, or alternatively, the HIF management subsystem 216 may ensure smooth communication between the CXL compliant memory system 204 and/or the CXL host 202, such as by maintaining compatibility and/or reliability of the CXL link, among other examples.

In some examples, the CXL compliant memory system 204 may be categorized as a CXL type 1 device, a CXL type 2 device, or a CXL type 3 device. A CXL type 1 device may be a device that implements a coherent cache using the CXL.cache protocol. A CXL type 2 device may be a device that implements both a coherent cache using the CXL.cache protocol and a host-managed device memory using the CXL.mem protocol. For example, a CXL type 2 device may be a hardware accelerator device. A CXL type 3 device may be a device that implements a host-managed device memory using the CXL.mem protocol. For example, a CXL type 3 device may be a memory expander device.

The number and arrangement of components shown in FIG. 2 are provided as an example. In practice, there may be additional components, fewer components, different components, or differently arranged components than those shown in FIG. 2. Furthermore, two or more components shown in FIG. 2 may be implemented within a single component, or a single component shown in FIG. 2 may be implemented as multiple, distributed components. Additionally, or alternatively, a set of components (e.g., one or more components) shown in FIG. 2 may perform one or more operations described as being performed by another set of components shown in FIG. 2.

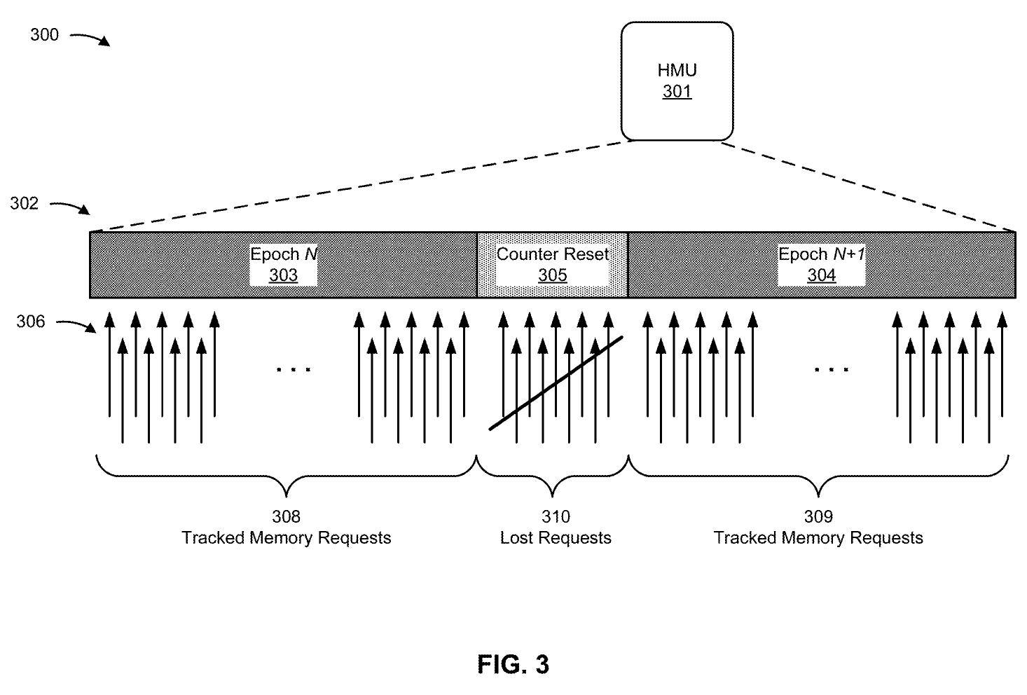

FIG. 3 is a diagram of an example 300 of lost requests associated with an access counter. In some examples, an HMU 301 of a memory controller (e.g., memory system controller 115, local controller 125, and/or main management subsystem 214, among other examples) may track accesses to a memory (e.g., memory arrays 130 and/or CXL device attached memory 218, among other examples). As used herein, “HMU” refers to an entity that monitors memory accesses and/or notifies a host system (e.g., host system 105 and/or CXL host 202, among other examples) of which memory pages and/or portions are hot. In some examples, the HMU 301 may monitor and/or count read or write accesses to a memory (e.g., the HMU 301 may monitor CXL.mem requests, among other examples) but may not count other commands, such as CXL.io commands or similar commands. As described in more detail below, in some examples the HMU 301 may manage and/or maintain one or more counting structures (sometimes referred to herein simply as “counters” for ease of description), which may correspond to a data structure that stores memory access statistics. Additionally, or alternatively, the HMU 301 may track memory access requests at a given time interval and/or monitoring period granularity, which is sometimes referred to herein as an epoch.

In such examples, the HMU 301 may reset the counters after each epoch, among other examples. Moreover, the HMU 301 may be unable to track memory accesses during a time period in which the counters are reset, leading to lost requests and/or inaccurate memory access tracking. More particularly, as indicated by reference number 302, the HMU 301 may be associated with alternating periods of time during which memory accesses are tracked by the HMU 301 using the counters and during which the counters are reset by the HMU 301. For example, the HMU 301 may monitor memory access requests during epochs, shown in FIG. 3 as a first epoch 303 (indexed in FIG. 3 as epoch N) and a second epoch 304 (indexed in FIG. 3 as epoch N+1). In some examples, the duration of the epoch 303, 304 may be set by the host system, such as via one or more registers, among other examples. Moreover, after an epoch has elapsed, the HMU 301 may reset the counters during a counter reset interval 305. Put another way, to guarantee precise counting within the epochs, the counters used for tracking the memory accessed may need to be periodically reset during the counter reset interval 305. After the counters have been reset (e.g., set to zero, among other examples), the HMU 301 may resume tracking memory accesses in a subsequent epoch. In this way, after the first epoch 303 (e.g., epoch N) has elapsed, the HMU 301 may pause counting during the counter reset interval 305, and then may again resume counting during the second epoch 304 (e.g., epoch N+1).

In some examples, in order for the HMU 301 to track memory accesses, a large quantity of counters (such as thousands or even millions of counters) may need to be used by the HMU 301. In such examples, resetting the numerous counters may result in the counter reset interval 305 being relatively long, leading to numerous lost requests (e.g., memory access requests that are not counted by the HMU 301), among other examples. More particularly, as indicated by reference number 306, a memory system may receive multiple memory access requests (e.g., CXL.mem requests) during the first epoch 303, the counter reset interval 305, and the second epoch 304. As indicated by reference numbers 308 and 309, the memory access requests received during the first epoch 303 and the second epoch 304, respectively, may be successfully counted and/or tracked by the HMU 301. However, as indicated by reference number 310, the memory access requests received during the counter reset interval 305 may not be successfully counted and/or tracked by the HMU 301, resulting in lost requests. Put another way, the HMU 301, while resetting the counters, may not be capable of tracking the incoming memory accesses, thus missing any requests received during the counter reset interval 305. In a relatively fast memory, this may result in hundreds to thousands of missed memory accesses in each counter reset interval 305, resulting in decreased tracking accuracy. For example, the HMU 301 may identify a hot memory page (e.g., a memory page for which a quantity of accesses received during an epoch satisfies a hotness threshold) as cold, resulting in inefficient memory allocation and/or memory operations.

As indicated above, FIG. 3 is provided as an example. Other examples may differ from what is described with regard to FIG. 3.

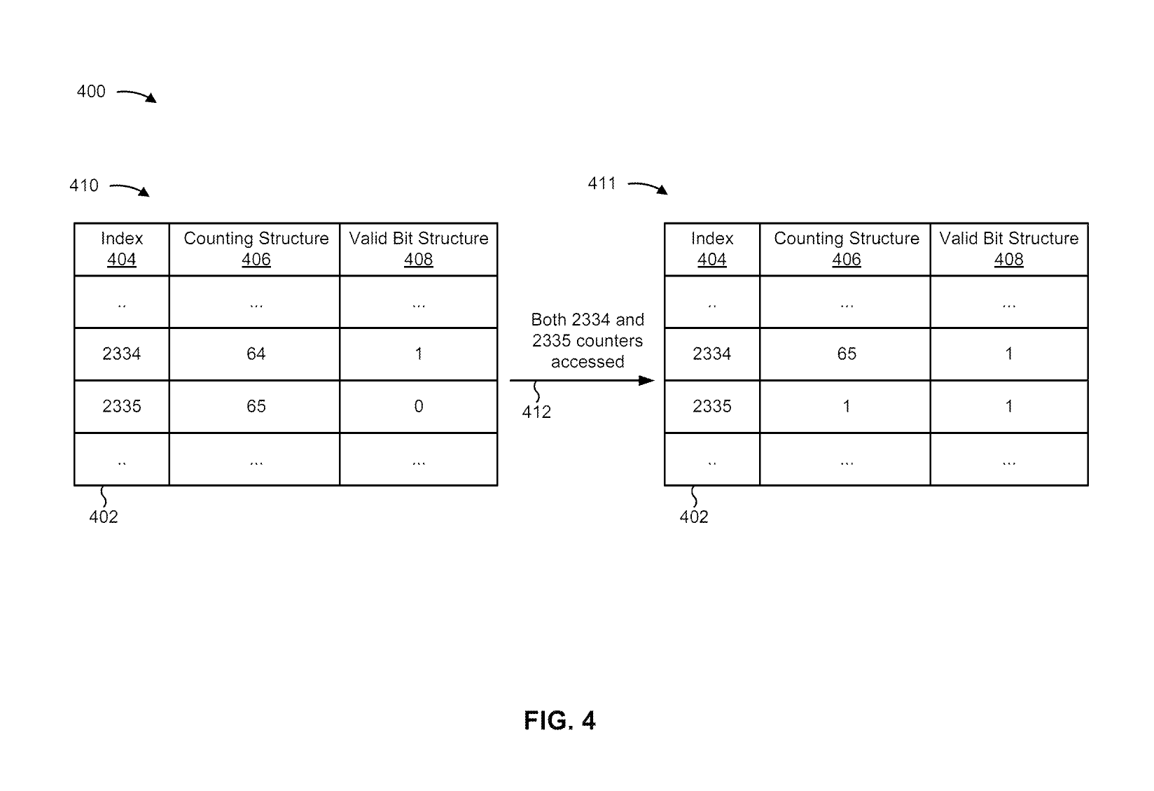

FIG. 4 is a diagram of an example 400 of tracking validity of access counters using valid bit structures. The operations described in connection with FIG. 4 may be performed by the memory system 110 and/or one or more components of the memory system 110, such as the memory system controller 115, one or more memory devices 120, and/or one or more local controllers 125; the CXL compliant memory system 204 and/or one or more components of the CXL compliant memory system 204, such as the CXL host interface hardware 210, the I/O path hardware logic and DMA controller 212, the main management subsystem 214, the HIF management subsystem 216, and/or the CXL device attached memory 218; and/or the HMU 301 and/or one or more components of the HMU 301.

As shown in example 400, a memory system may maintain a data structure 402 to manage and/or count memory accesses (e.g., CXL.mem requests) to portions of a memory. Although for ease of description the data structure 402 is shown as a single structure, in some other implementations the memory system may maintain multiple data structures that are accessed in parallel or serially, without departing from the scope of the disclosure. For example, the memory system may maintain a first data structure that includes multiple counters, each associated with a corresponding index, and a second data structure that includes multiple valid bit structures associated with a corresponding index. In such aspects, the indexes at each data structure may be used to associate each of one or more valid bit structures with a corresponding counter. For example, a counter located at index 2334 in the first data structure may be associated with a valid bit structure located at index 2334 in the second data structure.

Returning to the implementation shown in FIG. 4, the data structure 402 may include an index column 404, a counting structure column 406, and/or a valid bit structure column 408, among other examples. The index column 404 may indicate indexes associated with portions of a memory to be accessed by a host system. In that regard, the indexes may be memory addresses, may be associated with memory addresses, and/or may be otherwise mappable to memory addresses. In some implementations, each index may be associated with a portion of the memory that corresponds to a tracking granularity of the counting structures (which, in some implementations, may be set by a host system via one or more registers, among other examples). For example, in implementations in which the memory system is configured to track memory accesses at a page granularity, each index may uniquely correspond to a certain page of the memory.

The counting structure column 406 may include values of counters for each index indicated by the index column 404. In a similar manner as described above in connection with FIG. 3, the counters may be used to track accesses during a monitoring period (e.g., an epoch). In that regard, the memory system may be configured to increment a corresponding counter every time a memory access request targets a portion of memory that is associated with the counter.

The valid bit structure column 408 may include values of valid bits for each index indicated by the index column 404. As described in more detail below, in order to avoid missing numerous memory access requests associated with a counter reset interval (e.g., counter reset interval 305), a memory system associated with example 400 may forgo resetting the counters after each epoch. Instead, the memory system may maintain the valid bit structures to indicate whether the corresponding counter is valid for the current epoch (e.g., whether the corresponding counter accurately reflects accesses to the portion of the memory for the current epoch). For example, all valid bit structures may be reset to a first value (e.g., 0) at the end of an epoch (e.g., at the end of epoch N), meaning that any counters stored in the data structure 402 (which, as described above, themselves are not reset) are no longer valid for the next epoch (e.g., epoch N+1). Then, when a memory access is received in the next epoch (e.g., epoch N+1), the corresponding counter may be initialized (e.g., set to 1) and the corresponding valid bit structure may be set to a second value (e.g., 1) to indicate that that counter is now valid for the current epoch. Then, when the current epoch elapses, all valid bit structures may again be set to the first value (e.g., 0) while all counters may remain at their current values but no longer regarded as valid (e.g., because the valid bit structures have been reset to 0 to indicate that the counter values are no longer valid for the next epoch, such as epoch N+2). In this way, resetting the set of single-bit valid bit structures may be performed faster as compared to resetting a set of n-bits counters (e.g., the time required to reset the valid bit structures may be much smaller than the counter reset interval 305), thus reducing or eliminating lost requests, increasing the accuracy of access tracking, and/or reducing power, computing, and memory resource consumption associated with resetting memory access counters.

More particularly, reference number 410 shows the data structure 402 at a first time within a given epoch, and reference number 411 shows the data structure 402 at a second (later) time within the given epoch. As indicated by reference number 410, at the first time a counter value associated with index 2334 may be 64, and the corresponding valid bit structure may be set to 1 to indicate that the counter value is valid for the current epoch. Moreover, as further indicated by reference number 410, at the first time a counter value associated with index 2335 may be 65, but, unlike the valid bit structure for index 2334, the corresponding valid bit structure for index 2335 may be set to 0 to indicate that the counter value is invalid for the current epoch.

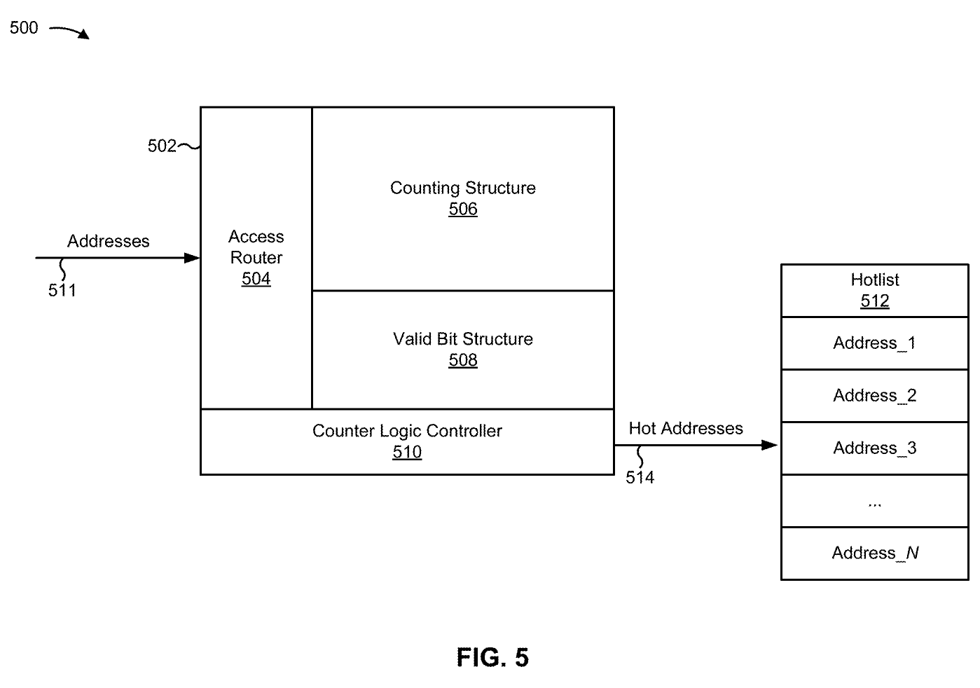

In such implementations, as a memory portion associated with index 2334 or index 2335 is accessed by the host system, the memory system may access the corresponding counter and associated valid bit (in parallel or serially) to determine if the corresponding counter value is valid and/or determine an appropriate course of action. More particularly, as indicated by reference number 412, during the epoch both a memory portion associated with index 2334 and a memory portion associated with index 2335 may be accessed. In such implementations, because, at the first time indicated by reference number 410, the valid bit structure for index 2334 was set to 1 (indicating that the counter was valid for the instant epoch), the memory system may simply increment the counter (e.g., from 64 to 65 in example 400) in response to receiving the memory request. Moreover, because, at the first time indicated by reference number 410, the valid bit structure for index 2335 was set to 0 (indicating that the counter was invalid for the instant epoch), the memory system may initialize the corresponding counter for index 2335 (e.g., set the counter to 1, reflecting that the memory access was the first one received for the memory portion associated with index 2335 during this epoch) and may set the valid bit structure to 1 (e.g., indicating that the counter is now valid for the instant epoch). Additional aspects regarding tracking memory accesses using counting structures and valid bit structures are described in more detail below in connection with FIG. 5.

As indicated above, FIG. 4 is provided as an example. Other examples may differ from what is described with regard to FIG. 4.

FIG. 5 is a diagram of an example 500 of components associated with tracking validity of access counters using valid bit structures. The components shown and described in connection with FIG. 5 may be associated with the memory system 110 and/or one or more components of the memory system 110, such as the memory system controller 115, one or more memory devices 120, and/or one or more local controllers 125; the CXL compliant memory system 204 and/or one or more components of the CXL compliant memory system 204, such as the CXL host interface hardware 210, the I/O path hardware logic and DMA controller 212, the main management subsystem 214; the HIF management subsystem 216, and/or the CXL device attached memory 218; and/or the HMU 301 and/or one or more components of the HMU 301.

Example 500 shows an HMU 502 (e.g., HMU 301) that may be used to track and/or count memory accesses (such as in a similar manner as described above in connection with FIG. 4). The HMU 502 may be associated with an access router 504, a counting structure 506, a valid bit structure 508, and/or a counter logic controller 510, among other examples. In such implementations, the access router 504 may be a component within the HMU 502 that is responsible for routing incoming memory access requests to the appropriate counting structures and/or valid bit structures. In some implementations, the access router 504 may act as an intermediary that directs each memory access request to the correct location in the data structures where the memory access statistics are maintained and/or updated.

The counting structure 506 may correspond to a data structure (e.g., data structure 402, and, more particularly, the counting structure column 406 and/or corresponding index column 404 of data structure 402) within the memory system that keeps track of the number of accesses to specific portions of memory during an epoch. In such implementations, each entry in the counting structure 506 may correspond to a counter that increments with each memory access to a particular memory portion, as described in detail above in connection with example 400.

In some implementations, the counting structure 506 may be associated with a statistical counter, such as a CBF-based hotness counter or a similar access counter. A CBF may utilize a probabilistic solution that counts elements of a data stream. In the context of a hotness counter, such as a hotness counter associated with a CXL device, a CBF may be used to estimate an access frequency on a particular CXL.mem channel, among other examples. In such implementations, a discrete physical address (DPA) of an incoming memory request may be decoded and/or aligned to a portion of a memory, such as for a purpose of deriving an identifier (ID) associated with the memory request. Moreover, the ID may be hashed into multiple (e.g., n)hash functions to derive indexes in the CBF where counters are incremented. In some implementations, the ID may be inserted into n hash functions to obtain n CBF indexes. In such implementations, counters associated with each CBF index may be updated (e.g., incremented). In some other implementations, the counting structure 506 may be associated with a different type of counter without departing from the scope of the disclosure, such as a sorted-lookup-table-based access counter, a hardware-based access counter, and/or a similar access counter.

The valid bit structure 508 may correspond to a data structure (e.g., data structure 402, and, more particularly, the valid bit structure column 408 and/or corresponding index column 404 of data structure 402) that indicates the validity of the corresponding counters in the counting structure 506 for the current epoch. In such implementations, each entry in the valid bit structure 508 may be a single bit that signifies whether the associated counter’s value is relevant and valid for the current monitoring period, as described in detail above in connection with example 400.

In some implementations, the valid bit structure 508 may be associated with a statistical counter, such as a valid-bit bloom filter (VBF)-based structure or similar. A VBF may be a variation of a traditional bloom filter utilized primarily to indicate the validity of elements (e.g., associated counters) rather than their presence or frequency. In some implementations, the VBF may be used to quickly reset and manage the validity of items without reinitializing the entire underlying data structures, in a similar manner as described above in connection with FIG. 4. Moreover, the VBF may use a simple bit array where each bit indicates the validity of an associated counter or entry. Additionally, or alternatively, and in a similar manner to the CBF described above, the VBF may use multiple (e.g., n) hash functions to map elements (e.g., DPAs) to positions in the bit array. In this way, in implementations in which the counting structure 506 is associated with the CBF described above and the valid bit structure 508 is associated with the VBF described above, the CBF may be used to track memory accesses, while the VBF may be used to support CBF reset operations, in a similar manner as described above in connection with FIG. 4.

The counter logic controller 510 may be a component that manages the logic for updating the counting structure and/or the valid bit structure. In some implementations, the counter logic controller 510 handles operations such as initializing counters, incrementing counters, and resetting the valid bit structure 508 at the end of an epoch. Additionally, or alternatively, the counter logic controller 510 may manage one or more data structures that indicate hot pages (e.g., one or more hotlists) and/or may output addresses to the one or more data structures that are associated with hot memory portions (e.g., memory portions for which a quantity of accesses during a given epoch satisfies a threshold), as described in more detail below.

In such implementations, when a given epoch terminates, the counter logic controller 510 may reset the valid bit structure 508 (e.g., set all entries to 0), but, as described above in connection with example 400, the counter logic controller 510 may refrain from resetting the counting structure 506. In this regard, the entries in the counting structure 506 may be maintained at the same values as they were at the end of the epoch, but the counter logic controller 510 may nonetheless be able to determine during the next epoch that those values are not valid (because all corresponding valid bits have been set to 0).

During the next epoch, as indicated by reference number 511, addresses associated with memory requests may be provided to the HMU 502 and, more particularly, to the access router 504 of the HMU 502. As a given memory access is tracked, the memory access may be associated with a counter at a certain index (referred to herein as index X for ease of description). Accordingly, and in a similar manner as described above in connection with FIG. 4, the counter at index X may be read and/or may have a specific value (referred to herein as index V(x) for ease of description), and the valid bit at index X may be read and/or may have a value of 0 (because all valid bits may have been reset to 0 prior to the instant epoch). In such implementations, the counter at index X may be set to 1 to reflect that the corresponding memory portion has now been accessed one time during the current epoch, and the valid bit at index X may be set to 1 to indicate that the corresponding counter (now at 1) is valid for the current epoch.

Later in the epoch, another memory access may be tracked and/or associated with index X. Accordingly, the counter at index X may be read and/or may have a value of 1 (e.g., V(x) = 1, as set earlier during the epoch as described above), and the valid bit at index X may be read and/or may have a value of 1 (also set earlier during the epoch as described above). In such implementations, the counter at index X may be incremented by one (e.g., set to 2) to reflect that the corresponding memory portion has now been accessed two times during the current epoch, and the valid bit at index X may be left unchanged (e.g., may remain at 1 to indicate that the corresponding counter (now at 2) is valid for the current epoch).

In some implementations, as a given portion of a memory becomes hot, a corresponding memory address and/or similar identifier may be added to a data structure accessible by a host system, such as the hotlist 512 shown in FIG. 5. The hotlist 512 is a data structure used to identify and keep track of memory pages or portions of memory that are frequently accessed, often referred to as “hot” pages. The hotlist 512 may be dynamically updated (e.g., by the counter logic controller 510) based on memory access patterns. In some implementations, the hotlist 512 may be used by the host system to optimize memory management by ensuring that these frequently accessed memory pages receive preferential treatment, such as being cached or allocated in faster tiers of memory in order to enhance the overall performance and efficiency of the memory system, among other examples. In this way, by accurately identifying and managing hot pages, the memory system and/or host system may reduce latency, improve caching efficiency, and/or optimize resource allocation for better system performance.

In some implementations, the memory system (e.g., the HMU 502 of the memory system) may be configured with a hotness threshold, such as via one or more registers accessible by the host system. A hotness threshold is a predefined value or criterion used to determine whether a particular memory page or portion of memory is considered “hot,” meaning the particular memory page or portion of memory is frequently accessed. In such implementations, when a quantity of accesses to a specific memory page within a given time period (e.g., epoch) exceeds this hotness threshold, that memory page is classified as “hot,” which may trigger specific actions, such as adding the memory page to the hotlist 512, among other examples (e.g., prioritizing the page for caching and/or migrating the page to faster memory to optimize access times and improve overall system performance). In such implementations, and as indicated by reference number 514, when a counter associated with a valid bit (e.g., 1) satisfies a threshold (e.g., a hotness threshold) during a given epoch, the counter logic controller may add an identifier (e.g., an address or similar identifier) associated with the counter and/or memory portion to the hotlist 512. On the other hand, the counter logic controller 510 may refrain from adding to the hotlist 512 any counters associated with an invalid bit (e.g., 0), because such (invalid) counters are not reflective of a hot portion of memory for the given epoch.

As indicated above, FIG. 5 is provided as an example. Other examples may differ from what is described with regard to FIG. 5.

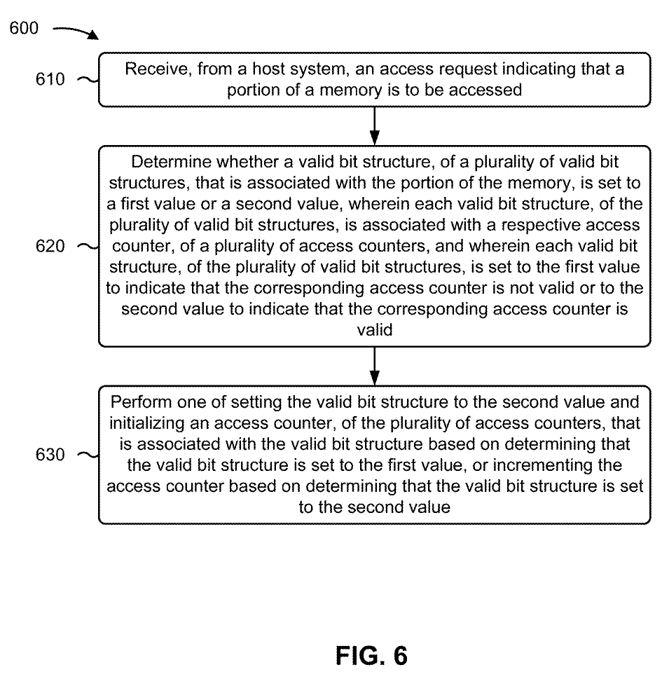

FIG. 6 is a flowchart of an example method 600 associated with tracking validity of access counters using valid bit structures. In some implementations, a memory system (e.g., the memory system 110 and/or CXL compliant memory system 204) may perform or may be configured to perform the method 600. In some implementations, another device or a group of devices separate from or including the memory system (e.g., host system 105 and/or CXL host 202) may perform or may be configured to perform the method 600. Additionally, or alternatively, one or more components of the memory system (e.g., memory system controller 115, CXL host interface hardware 210, I/O path hardware logic and DMA controller 212, main management subsystem 214, HIF management subsystem 216, CXL device attached memory 218, HMU 301, and/or HMU 502) may perform or may be configured to perform the method 600. Thus, means for performing the method 600 may include the memory system and/or one or more components of the memory system. Additionally, or alternatively, a non-transitory computer-readable medium may store one or more instructions that, when executed by the memory system, cause the memory system to perform the method 600.

As shown in FIG. 6, the method 600 may include receiving, from a host system, an access request indicating that a portion of a memory is to be accessed (block 610). For example, as described above in connection with reference numbers 412 and 511, the memory system may receive a CXL.mem command or similar request indicating that a portion of a memory is to be written to or read from, among other examples.

As further shown in FIG. 6, the method 600 may include determining whether a valid bit structure, of a plurality of valid bit structures, that is associated with the portion of the memory, is set to a first value or a second value, wherein each valid bit structure, of the plurality of valid bit structures, is associated with a respective access counter, of a plurality of access counters, and wherein each valid bit structure, of the plurality of valid bit structures, is set to the first value to indicate that the corresponding access counter is not valid or to the second value to indicate that the corresponding access counter is valid (block 620). For example, in a similar manner as described above in connection with FIG. 4, the memory system may maintain one or more data structures (e.g., data structure 402) that associates memory portions and/or counters with specific indexes and/or which associates valid bit structures with the indexes. In such implementations, the memory system may determine whether a valid bit structure that is associated with an index corresponding to the memory access request is set to 0, indicating that the corresponding counter value is not valid, or else is set to 1, indicating that the corresponding counter value is valid.

As further shown in FIG. 6, the method 600 may include performing one of setting the valid bit structure to the second value and initializing an access counter, of the plurality of access counters, that is associated with the valid bit structure based on determining that the valid bit structure is set to the first value, or incrementing the access counter based on determining that the valid bit structure is set to the second value (block 630). For example, in a similar manner as described above in connection with FIGS. 4 and 5, when the valid bit structure is set to 0 (e.g., to indicate that corresponding counter value is invalid for the current epoch), the memory system may initialize the counter (e.g., set the counter to 1) and may set the valid bit counter to 1 to indicate that the initialized counter is now valid for the instant epoch. On the other hand, when the valid bit structure is set to 1 (e.g., to indicate that corresponding counter value is valid for the current epoch), the memory system may increment the counter to reflect the instant memory access.

The method 600 may include additional aspects, such as any single aspect or any combination of aspects described below and/or described in connection with one or more other methods or operations described elsewhere herein.

In a first aspect, the method 600 further comprises setting, by the memory system and based on the monitoring period elapsing, the plurality of valid bit structures to the first value. For example, in a similar manner as described above in connection with FIGS. 4 and 5, in some implementations the memory system may reset all valid bit structures to 0 at the end of an epoch to indicate that the counter values (which may remain at their current values, as described above) are no longer valid for the next epoch.

In a second aspect, alone or in combination with the first aspect, the method 600 includes maintaining, by the memory system, the plurality of access counters at their respective values when setting the plurality of valid bit structures to the first value. For example, in a similar manner as described above in connection with FIGS. 4 and 5, in some implementations the memory system may maintain all counters at their current values at the end of an epoch, such as for a purpose of reducing the counter reset interval (e.g., counter reset interval 305) at the end of each epoch and thus reducing or eliminating lost requests (e.g., the lost requests described above in connection with reference number 310).

In a third aspect, alone or in combination with one or more of the first and second aspects, the method 600 includes determining, by the memory system, that the access counter satisfies a threshold, and adding, by the memory system, an identifier associated with the portion of the memory to a data structure based on determining that the access counter satisfies the threshold. For example, in a similar manner as described above in connection with FIG. 5, the memory system (more particularly, the counter logic controller 510) may add an identifier associated with a hot portion of a memory to the hotlist 512 when a corresponding valid counter (e.g., a counter associated with a valid bit of 1) satisfies a hotness threshold during an epoch, among other examples.

In a fourth aspect, alone or in combination with one or more of the first through third aspects, the threshold is associated with a hotness threshold set by the host system, and the data structure is associated with a hotlist accessible by the host system. For example, in a similar manner as described above in connection with the hotlist 512 of FIG. 5, the memory system may receive an indication of the hotness threshold from the host system (e.g., via one or more registers associated with the memory system) and/or the hotlist 512 may be accessible by the host system (such as for a purpose of optimizing memory management by ensuring that frequently accessed memory pages receive preferential treatment by being cached and/or allocated in faster tiers of memory).

In a fifth aspect, alone or in combination with one or more of the first through fourth aspects, the valid bit structure is associated with a valid-bit bloom filter, and the access counter is associated with a counting bloom filter. For example, in a similar manner as described above in connection with FIG. 5, the counting structure 506 may be associated with a CBF and/or the valid bit structure 508 may be associated with a VBF.

In a sixth aspect, alone or in combination with one or more of the first through fifth aspects, initializing the access counter includes setting the access counter to a value of 1. For example, in a similar manner as described above in connection with FIGS. 4 and 5, when a valid bit structure indicates that the access counter for a given memory request is invalid, the memory system may set or initialize the counter by setting the counter to 1, indicating that the instant memory access request is the first request for the given epoch.

In a seventh aspect, alone or in combination with one or more of the first through sixth aspects, the first value is one of 0 or 1, and the second value is the other one of 0 or 1. For example, in a similar manner as described above in connection with FIGS. 4 and 5, the valid bit structure may be set to 0 to indicate that the corresponding counter value is invalid for the current epoch, and the valid bit structure may be set to 1 to indicate that the corresponding counter value is valid for the current epoch.

Although FIG. 6 shows example blocks of a method 600, in some implementations, the method 600 may include additional blocks, fewer blocks, different blocks, or differently arranged blocks than those depicted in FIG. 6. Additionally, or alternatively, two or more of the blocks of the method 600 may be performed in parallel. The method 600 is an example of one method that may be performed by one or more devices described herein. These one or more devices may perform or may be configured to perform one or more other methods based on operations described herein.

In some implementations, a memory system includes one or more components configured to: receive, from a host system, an access request indicating that a portion of a memory is to be accessed; determine whether a valid bit structure, of a plurality of valid bit structures, that is associated with the portion of the memory, is set to a first value or a second value, wherein each valid bit structure, of the plurality of valid bit structures, is associated with a respective access counter, of a plurality of access counters, and wherein each valid bit structure, of the plurality of valid bit structures, is set to the first value to indicate that the corresponding access counter is not valid or to the second value to indicate that the corresponding access counter is valid; and one of: set the valid bit structure to the second value and initialize an access counter, of the plurality of access counters, that is associated with the valid bit structure based on determining that the valid bit structure is set to the first value, or increment the access counter based on determining that the valid bit structure is set to the second value.

In some implementations, a method includes receiving, by a memory system and from a host system, an access request indicating that a portion of a memory is to be accessed; determining, by the memory system, whether a valid bit structure, of a plurality of valid bit structures, that is associated with the portion of the memory, is set to a first value or a second value, wherein each valid bit structure, of the plurality of valid bit structures, is associated with a respective access counter, of a plurality of access counters, and wherein each valid bit structure, of the plurality of valid bit structures, is set to the first value to indicate that the corresponding access counter is not valid or to the second value to indicate that the corresponding access counter is valid; and performing, by the memory system, one of: setting the valid bit structure to the second value and initializing an access counter, of the plurality of access counters, that is associated with the valid bit structure based on determining that the valid bit structure is set to the first value, or incrementing the access counter based on determining that the valid bit structure is set to the second value.

In some implementations, a CXL compliant memory system includes one or more components configured to: receive, from a CXL compliant host system, a CXL.mem request indicating that a portion of a memory is to be accessed; determine whether a valid bit structure, of a plurality of valid bit structures, that is associated with the portion of the memory, is set to 0 or 1, wherein each valid bit structure, of the plurality of valid bit structures, is associated with a respective counter structure, of a plurality of counter structures, and wherein each valid bit structure, of the plurality of valid bit structures, is set to 0 to indicate that the corresponding counter structure is not valid or 1 to indicate that the corresponding counter structure is valid; and one of: set the valid bit structure to 1 and set a counter structure, of the plurality of counter structures, that is associated with the valid bit structure to 1 based on determining that the valid bit structure is set to 0, or increment the counter structure based on determining that the valid bit structure is set to 1.

The foregoing disclosure provides illustration and description but is not intended to be exhaustive or to limit the implementations to the precise forms disclosed. Modifications and variations may be made in light of the above disclosure or may be acquired from practice of the implementations described herein.

As used herein, the terms “substantially” and “approximately” mean “within reasonable tolerances of manufacturing and measurement.” As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (e.g., a + a, a + a + a, a + a + b, a + a + c, a + b + b, a + c + c, b + b, b + b + b, b + b + c, c + c, and c + c + c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. A memory system, comprising:
one or more components configured to:
receive, from a host system, an access request indicating that a portion of a memory is to be accessed;
determine whether a valid bit structure, of a plurality of valid bit structures, that is associated with the portion of the memory, is set to a first value or a second value,
wherein each valid bit structure, of the plurality of valid bit structures, is associated with a respective access counter, of a plurality of access counters, and
wherein each valid bit structure, of the plurality of valid bit structures, is set to the first value to indicate that the corresponding access counter is not valid or to the second value to indicate that the corresponding access counter is valid; and
one of:
set the valid bit structure to the second value and initialize an access counter, of the plurality of access counters, that is associated with the valid bit structure based on determining that the valid bit structure is set to the first value, or
increment the access counter based on determining that the valid bit structure is set to the second value.

2. The memory system of claim 1, wherein the access request is received during a monitoring period, and
wherein the one or more components are further configured to set, based on the monitoring period elapsing, the plurality of valid bit structures to the first value.

3. The memory system of claim 2, wherein the one or more components are further configured to maintain the plurality of access counters at their respective values when setting the plurality of valid bit structures to the first value.

4. The memory system of claim 1, wherein the one or more components are further configured to:
determine that the access counter satisfies a threshold; and
add an identifier associated with the portion of the memory to a data structure based on determining that the access counter satisfies the threshold.

5. The memory system of claim 4, wherein the threshold is associated with a hotness threshold set by the host system, and
wherein the data structure is associated with a hotlist accessible by the host system.

6. The memory system of claim 1, wherein the valid bit structure is associated with a valid-bit bloom filter, and
wherein the access counter is associated with a counting bloom filter.

7. The memory system of claim 1, wherein the one or more components, to initialize the access counter, are configured to set the access counter to a value of 1.

8. The memory system of claim 1, wherein the first value is one of 0 or 1, and
wherein the second value is the other one of 0 or 1.

9. A method, comprising:
receiving, by a memory system and from a host system, an access request indicating that a portion of a memory is to be accessed;
determining, by the memory system, whether a valid bit structure, of a plurality of valid bit structures, that is associated with the portion of the memory, is set to a first value or a second value,
wherein each valid bit structure, of the plurality of valid bit structures, is associated with a respective access counter, of a plurality of access counters, and
wherein each valid bit structure, of the plurality of valid bit structures, is set to the first value to indicate that the corresponding access counter is not valid or to the second value to indicate that the corresponding access counter is valid; and
performing, by the memory system, one of:
setting the valid bit structure to the second value and initializing an access counter, of the plurality of access counters, that is associated with the valid bit structure based on determining that the valid bit structure is set to the first value, or
incrementing the access counter based on determining that the valid bit structure is set to the second value.

10. The method claim 9, wherein the access request is received during a monitoring period, and
wherein the method further comprises setting, by the memory system and based on the monitoring period elapsing, the plurality of valid bit structures to the first value.

11. The method of claim 10, further comprising maintaining, by the memory system, the plurality of access counters at their respective values when setting the plurality of valid bit structures to the first value.

12. The method of claim 9, further comprising:
determining, by the memory system, that the access counter satisfies a threshold; and
adding, by the memory system, an identifier associated with the portion of the memory to a data structure based on determining that the access counter satisfies the threshold.

13. The method of claim 12, wherein the threshold is associated with a hotness threshold set by the host system, and
wherein the data structure is associated with a hotlist accessible by the host system.

14. The method of claim 9, wherein the valid bit structure is associated with a valid-bit bloom filter, and
wherein the access counter is associated with a counting bloom filter.

15. The method of claim 9, wherein initializing the access counter includes setting the access counter to a value of 1.

16. The method of claim 9, wherein the first value is one of 0 or 1, and
wherein the second value is the other one of 0 or 1.

17. A compute express link (CXL) compliant memory system, comprising:
one or more components configured to:
receive, from a CXL compliant host system, a CXL.mem request indicating that a portion of a memory is to be accessed;
determine whether a valid bit structure, of a plurality of valid bit structures, that is associated with the portion of the memory, is set to 0 or 1,
wherein each valid bit structure, of the plurality of valid bit structures, is associated with a respective counter structure, of a plurality of counter structures, and
wherein each valid bit structure, of the plurality of valid bit structures, is set to 0 to indicate that the corresponding counter structure is not valid or 1 to indicate that the corresponding counter structure is valid; and
one of:
set the valid bit structure to 1 and set a counter structure, of the plurality of counter structures, that is associated with the valid bit structure to 1 based on determining that the valid bit structure is set to 0, or
increment the counter structure based on determining that the valid bit structure is set to 1.

18. The CXL compliant memory system of claim 17, wherein the CXL.mem request is received during an epoch, and
wherein the one or more components are further configured to set, based on the epoch elapsing, the plurality of valid bit structures to 0.

19. The CXL compliant memory system of claim 18, wherein the one or more components are further configured to maintain the plurality of counter structures at their respective values when setting the plurality of valid bit structures to 0.

20. The CXL compliant memory system of claim 17, wherein the one or more components are further configured to:
determine that the counter structure satisfies a hotness threshold; and
add an identifier associated with the portion of the memory to a hotlist based on determining that the counter structure satisfies the hotness threshold.

21. The CXL compliant memory system of claim 20, wherein the hotness threshold is set by the CXL compliant host system, and
wherein the hotlist is accessible by the CXL compliant host system.

22. The CXL compliant memory system of claim 17, wherein the valid bit structure is associated with a valid-bit bloom filter, and
wherein the counter structure is associated with a counting bloom filter.
